(19) United States
(12) Patent Application Publication
(10) Pub. No.: US 2007/0149378 A1
(43) Pub. Date: Jun. 28, 2007

(54) Centrifugal separator

(76) Inventors: Kahoru Takahashi, Hitachinaka-shi (JP); Hiroyuki Takahashi, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/520,648

(22) Filed: Sep. 14, 2006

(30) Foreign Application Priority Data
Sep. 14, 2005 (JP) P2005-266697

(51) Int. Cl. B04B 11/04

(52) U.S. Cl. 494/1; 494/7; 494/10

(57) ABSTRACT

A centrifugal separator includes a counter and an operation/display unit. When performing centrifugation, a runtime select button and a temperature select button in the operation/display unit may be pressed simultaneously to activate the counter, for example. At the beginning of the centrifugation process, the controller detects the start of the operation and increments the count value in the counter. At the end of the centrifugation process, the runtime display unit displays the count value held by the counter for a prescribed time, while the temperature display unit simultaneously displays the preset number of centrifugation processes. The user can visually confirm the count value and the setting for the number of processes before executing the next operation, thereby preventing the user from losing track of the progress and performing an incorrect operation. The counter can also be set to a non-operating state to prevent the count value in the counter from being incremented.

### BACKGROUND OF THE INVENTION

1. Field of the Invention

The present invention relates to a centrifugal separator, and more particularly to a centrifugal separator provided with a function for counting the number of times the centrifugal separator performs an operation.

2. Description of the Related Art

In the field of molecular biology, it is necessary to subject a single sample to a sequence of centrifugation steps ranging in number from about 3 to 10 when extracting genomic DNA or plasmid DNA as a pre-process for genomic analysis. Generally, the processes performed between each centrifugation step are different and for the most cases each centrifugation step is different as well.

Further, the extraction operation is performed on numerous samples, ordinarily 96 or 192 samples. However, a single centrifugal separator used for this purpose is generally capable of processing about 20-30 samples at one time, requiring the centrifugal separator to perform the same centrifugation steps a plurality of times. Hence, the centrifugation step must be performed a total of at least tens of times and at most about one hundred times. Since the centrifugation operations are performed numerous times in this way, it is important to maintain awareness of the number of the current centrifugation operation and the number of the group to which the current centrifugation operation belongs.

In the field of centrifugal separators, Japanese patent application publication No. HEI-5-195980 proposes a function for obtaining the operation history of the centrifugal separator. Japanese patent application publications Nos. HEI-4-367750 and SHO-55-88858 propose a function for counting the usage history of the rotary body in the centrifugal separator. Japanese Patent No. 3,496,520 proposes a function for accumulating the runtime for a member of the centrifugal separator. Centrifugal separators have also appeared on the market with a function for displaying the cumulative rotations or cumulative runtime of a drive motor using a total counter or an hour meter.

Since the operations performed between the centrifugal steps in the genomic DNA and plasmid DNA extraction described above differ according to the step with regard to the injected reagent and temperature for the heat treatment, the operator has to know which step the sample has reached in the processing. However, since operators often manage this progress relying on their memory or brief notes, there is a risk of the operator losing track of this progress due to an unexpected interruption for another operation or as a result of forgetting to make a note and repeating the same process over. An incorrect centrifugal process may result in insufficient centrifugation, making it impossible to obtain a sufficient amount of the target precipitate, or in deactivation and breakdown of a sample that should have been processed for only a short time.

The conventional technologies disclosed in the prior art references mentioned above, or the technology for displaying the cumulative rotations and the cumulative runtime using a total counter or hour meter are designed for determining when the life of the device or a component in the device has expired. Accordingly, these technologies do not facilitate the user in changing values and only control the runtime without assisting the user in determining the operation number. These technologies are also not suitable for determining the number of centrifugation operations for each of a plurality of exchangeable rotors by counting the number of rotations for each.

### SUMMARY OF THE INVENTION

In view of the foregoing, it is an object of the present invention to provide means for tracking the progress in a process including a plurality of centrifugation operations.

It is another object of the present invention to provide inexpensive means for acquiring the frequency of use of a centrifugal separator.

In order to achieve the above and other objects, there is provided a centrifugal separator including: a rotor having a holding portion for holding a sample subject to separation through centrifugation; a motor operatively connected to the rotor for driving the rotor to rotate; a controller that is configured to control the motor; an operation/display unit that is configured to set and display drive operations of the motor controlled by the controller; a counter unit that counts number of centrifugation processes; and a count display unit that displays a value maintained by the counter unit indicating the number of centrifugation processes counted by the counter.

The centrifugal separator stated above may further include a counter activating unit that activates the counter unit. The counter unit counts the number of centrifugation processes only when having been activated by the counter activating unit.

Preferably, the counter unit may include a plurality of counters, each counter being configured to count the number of centrifugation processes. The counter activating unit selectively activates at least one of the plurality of counters. The counter activated by the counter activating unit counts the number of centrifugation processes. In this case, the number of centrifugation processes is counted by counting each time centrifugation is started or stopped.

A counter identifying data display unit may further be provided for displaying counter identifying data indicating the counters selected by the counter activating unit.

In addition to the counter identifying data display unit or separately from the counter identifying data display unit, a target value display unit may further be provided for displaying a target count for the counters selected by the counter activating unit.

The centrifugal separator may further include a count halting unit that halts centrifugation processes counting operations of the at least one of the plurality of counters.

The count display unit may be disposed in the operation/display unit and function to display an operating status of the centrifugal separator.

The centrifugal separator according to the present invention counts the total number of operations and automatically counts the number of centrifugation processes for each of a plurality of different processes and enables a user to view these values. Therefore, the centrifugal separator can prevent the user from, for example, losing track of the progress in genomic DNA or plasmid DNA extraction steps and performing an incorrect process. Further, the centrifugal separator according to the present invention enables the user to easily determine progress, not only in genomic DNA and plasmid DNA extraction, but also in various operations that include centrifugal separation steps, such as total RNA and messenger RNA extraction, separation for intercellular organelle, biological protein regulation, blood separation at blood testing centers, and pharmaceutical processes including centrifugation.

### BRIEF DESCRIPTION OF THE DRAWINGS

The particular features and advantages of the invention as well as other objects will become apparent from the following description taken in connection with the accompanying drawings, in which:

FIG. 1 is an explanatory diagram showing the structure of a centrifugal separator according to a first embodiment of the invention;

FIG. 2 is an explanatory diagram showing the structure of an operation/display unit;

FIG. 3 is a flowchart illustrating steps in a process 20;

FIG. 4 is an explanatory diagram illustrating the state of processes for various groups and the state of operations in the centrifugal separator for a 96-sample process;

FIG. 5 is a flowchart illustrating steps in a centrifugation process performed in the 96-sample process;

FIG. 6 is a flowchart illustrating steps in a separate centrifugation process;

FIG. 7 is an explanatory diagram showing the structure of a display unit according to a second embodiment of the invention;

FIG. 8 is an explanatory diagram showing the configuration of a count display unit shown in FIG. 7;

FIG. 9 is an explanatory diagram showing the structure of an operating unit;

FIG. 10A is a flowchart illustrating a part of steps in a process 100;

FIG. 10B is a flowchart illustrating a remaining part of steps in the process 100; and

FIG. 11 is a flowchart illustrating operations during a centrifugation.

### DETAILED DESCRIPTION OF THE PREFERRED EMBODIMENTS

A centrifugal separator according to preferred embodiments of the invention will be described while referring to the accompanying drawings.

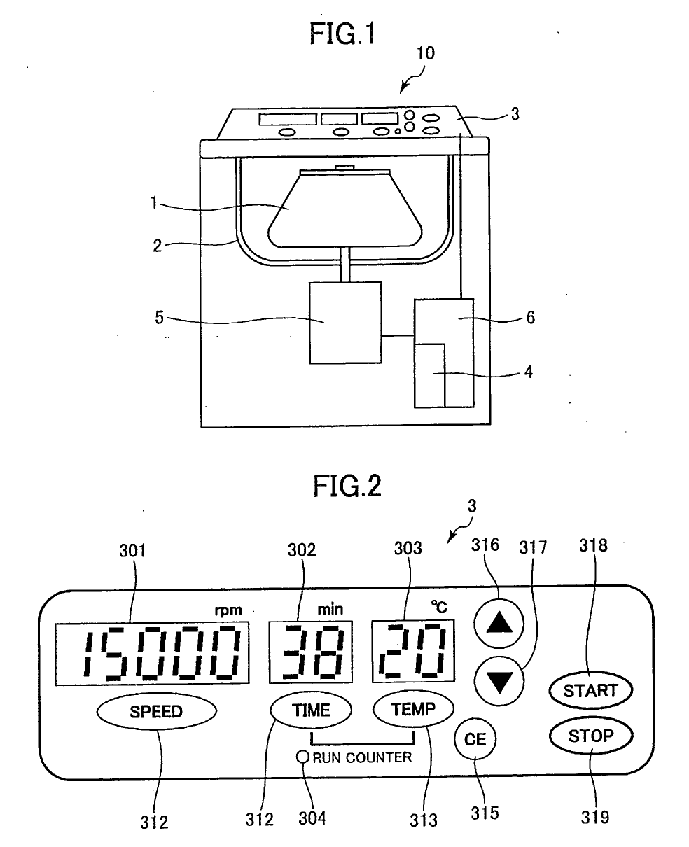

FIGS. 1 through 6 are explanatory diagrams illustrating the structure and operations of a centrifugal separator according to a first embodiment of the invention. FIG. 1 shows the structure of a centrifugal separator 10 according to the first embodiment. As shown in FIG. 1, the centrifugal separator 10 includes a rotor 1 that holds and rotates a sample to be separated; a rotor chamber 2 in which the rotor 1 is provided; a motor 5 for rotating the rotor 1; a controller 6 for controlling the rotation of the motor 5; and an operation/display unit 3 for displaying the operating state of the centrifugal separator 10 or for inputting operating conditions. The controller 6 also includes a counter 4 that counts up each time a centrifugation process is started. Alternatively, the counter 4 may count up each time the centrifugation process is stopped.

FIG. 2 shows an example of the operation/display unit 3 provided in the centrifugal separator 10 of the first embodiment. As shown in FIG. 2, the operation/display unit 3 includes a rotational speed display unit 301, a rotational speed select button (SPEED) 311, a runtime display unit 302, and runtime select button (TIME) 312, a temperature display unit 303, a temperature select button (TEMP) 313, a counter operation lamp (RUN COUNTER) 304, a cancellation button (CE) 315, an increment button 316, a decrement button 317, a start button (START) 318, and a stop button (STOP) 319.

The rotational speed display unit 301 displays the rotational speed of the rotor 1 that has been set for the centrifugation process and the rotational speed when the centrifugal separator 10 is operating. The rotational speed select button (SPEED) 311 is pressed to enable setting or modification of the rotational speed. After the rotational speed has been set or modified, the rotational speed display unit 301 will display the actual (current) number of revolutions when the start button (START) 318 is pressed. The runtime display unit 302 displays the process time for a centrifugation process and displays the elapsed time of a centrifugation process after the centrifugal separator 10 begins operating. The runtime select button (TIME) 312 is pressed to enable setting or modification of the process time, that is, the run time for the centrifugation process. When the start button (START) 318 is pressed after the process time has been set or modified, the runtime display unit 302 displays the elapsed time of the centrifugation process. The temperature display unit 303 displays the temperature set for a centrifugation process and the actual temperature when the centrifugal separator 10 is operating. The temperature select button (TEMP) 313 is pressed to enable setting or modification of the process temperature. When the start button (START) 318 is pressed after the process temperature has been set or modified, the temperature display unit 303 displays the current temperature. Each button may also be given a separate function when pressed simultaneously and in combination with other buttons.

The counter operation lamp (RUN COUNTER) 304 lights when the counter 4 is operating. At this time, the runtime display unit 302 displays the count value indicating the number of centrifugation processes, while the temperature display unit 303 displays the scheduled number of centrifugation processes. The cancellation button (CE) 315 is pressed when zeroing the value of the counter 4, for example. The increment button 316 and decrement button 317 can be operated to increase or decrease one of various settings after pressing one of the rotational speed select button (SPEED) 311, runtime select button (TIME) 312, and temperature select button (TEMP) 313, for example. Any one of the buttons on the operation/display unit 3 may be given a function to disable the counting operation of the counter 4 when used in combination with another button. The start button (START) 318 and stop button (STOP) 319 are pressed to start or stop a centrifugation process executed by the centrifugal separator 10.

The counter 4 provided in the controller 6 may be made operable by simultaneously pressing both of the runtime select button (TIME) 312 and temperature select button (TEMP) 313 in the operation/display unit 3, for example. The counter 4 functions to count each time the centrifugal separator 10 starts or stops a centrifugation process.

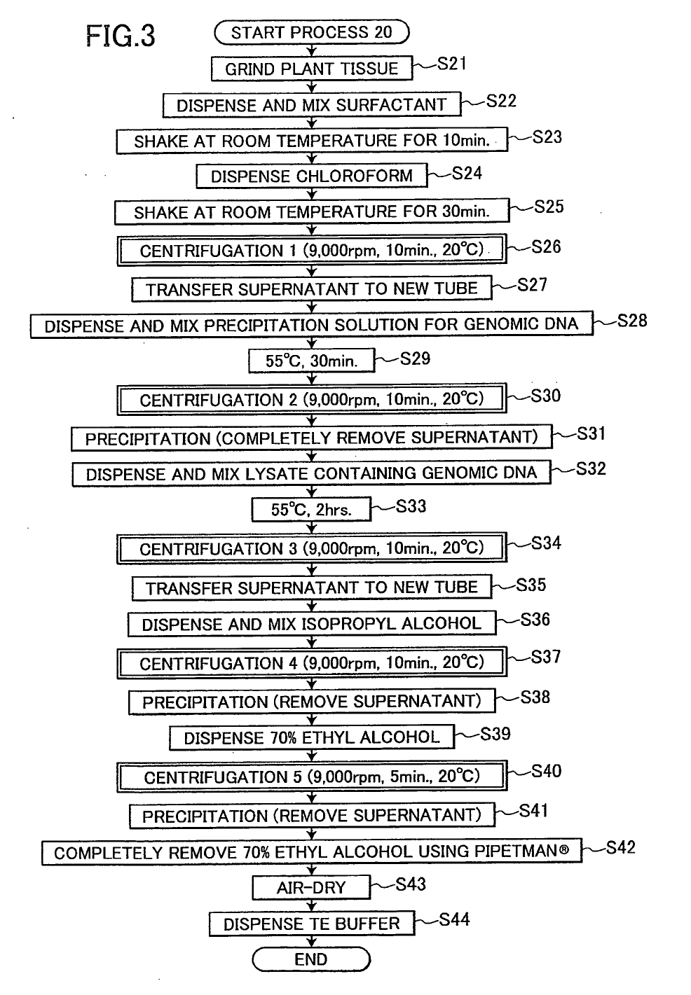

Next, a process performed with the centrifugal separator 10 having this construction will be described. FIG. 3 is a flowchart illustrating steps in a process 20 performed on the centrifugal separator 10. The process 20 is an example of a genomic DNA extraction protocol. As shown in FIG. 3, the process 20 includes a total of five centrifugation steps, that is, centrifugations 1-5 in S26, S30, S34, S37, and S40. Each process performed between centrifugation steps, that is, S21-S25, S27-S29, S31-S33, S35-S36, and S38-S39 are all different. Further, while centrifugation steps 1-4 all call for a rotational speed of 9,000 rpm, a runtime of 10 minutes, and an operating temperature of 20° C., centrifugation 5 differs in that the runtime is 5 minutes.

In the process 20 described above, if centrifugation 5 is mistakenly performed instead of the 10-minute centrifugation 4, the desired amount of precipitate cannot be obtained. On the other hand, if the 10-minute centrifugation 4 is performed on a sample that has reached the state of centrifugation 5, the sample may be deactivated or broken down because the processing time is too long. For these reasons, it is necessary to perform the process precisely.

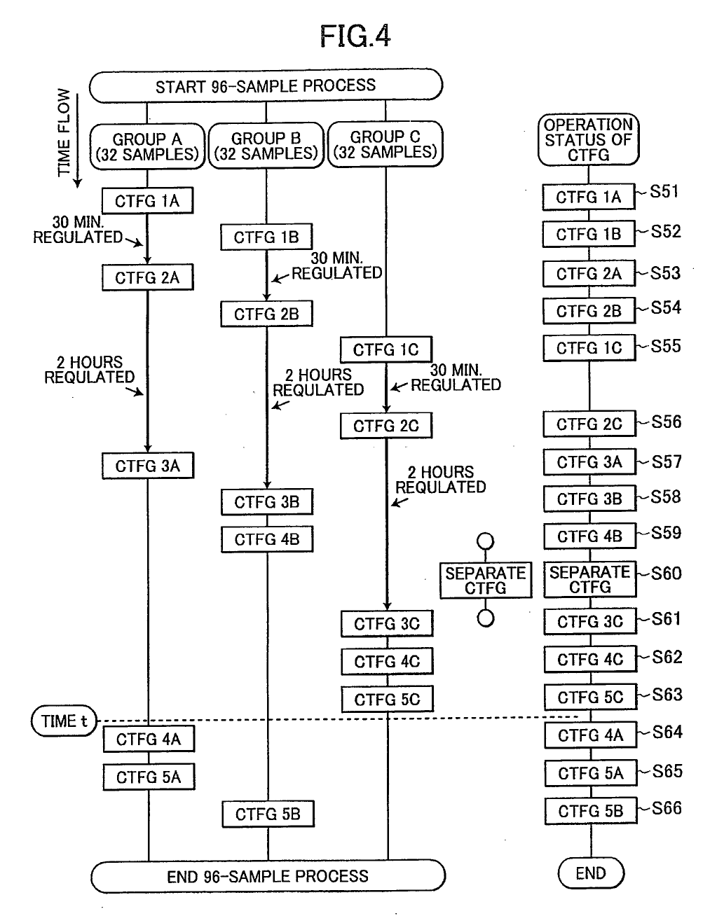

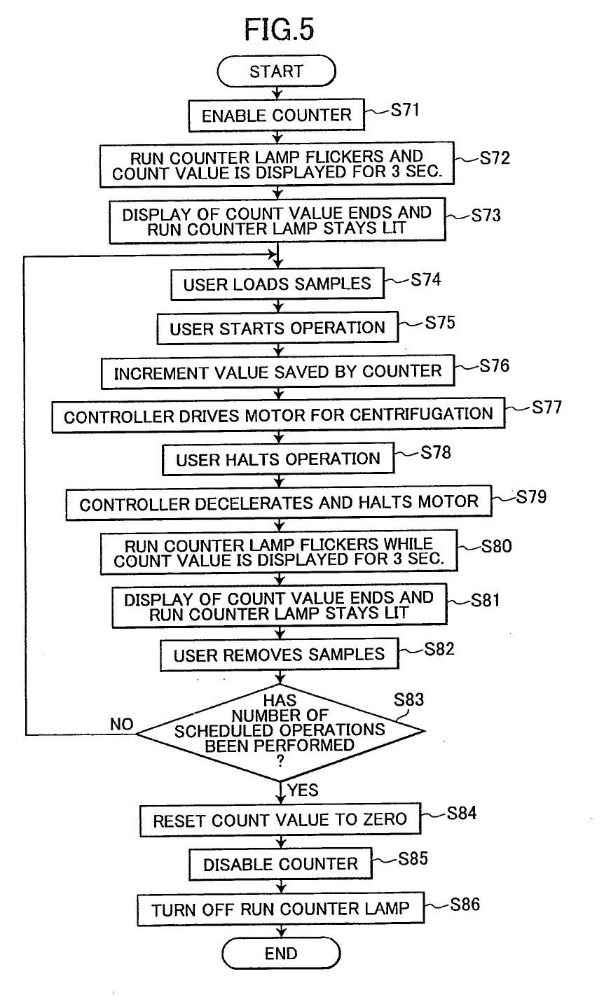

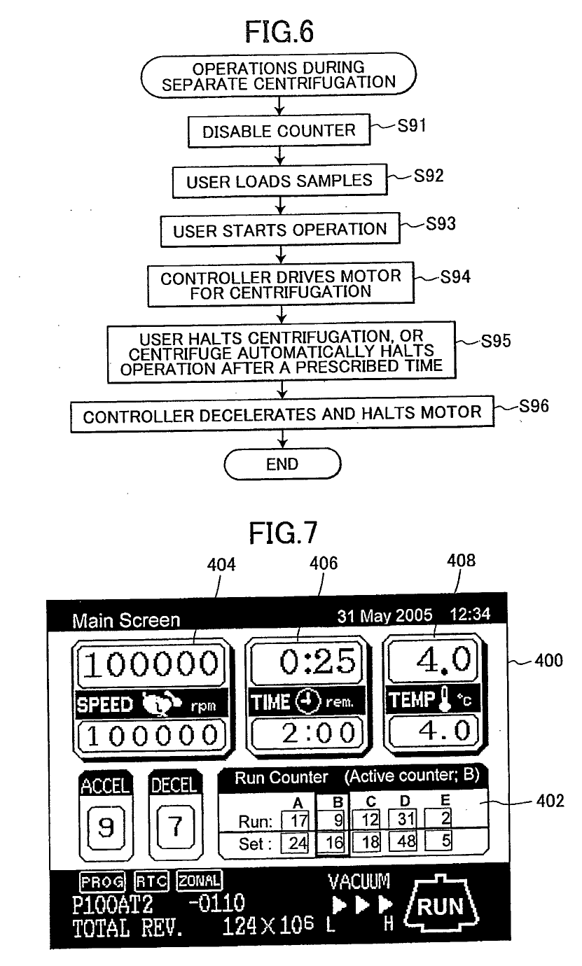

Next, the process 20 will be described for a process performed on 96 samples (hereinafter referred to as the 96-sample process) with reference to FIGS. 4 through 6. FIG. 4 shows the operating status for each group in the 96-sample process and the operating status of the centrifugal separator 10. FIG. 5 is a flowchart illustrating steps in the centrifugation process. FIG. 6 is a flowchart illustrating steps in a separate centrifugation operation.

When a single centrifugal separator 10 is used as the centrifuge for the 96-sample process, the rotor 1 of the centrifugal separator 10 is capable of processing up to 32 samples at one time. Hence, the 96 samples are divided into groups A, B, and C having 32 samples each, and the centrifugal separator 10 performs centrifugation for each group. In FIG. 4, the passage of time is represented vertically. The details of processes performed between each centrifugation operation are not shown for simplification. The protocol for the process 20 includes five centrifugation steps, as described above. The first centrifugation step will be referred to as centrifugation 1, the second step as centrifugation 2, and so on for centrifugation 3, 4, and 5. The letters A, B, and C will also be appended after the number to indicate a specific group. For example, the centrifugation 1 step performed on samples in Group A will be expressed as “centrifugation 1A.” As was described with reference to the flowchart in FIG. 3, the runtime is 10 minutes for centrifugation 1-4 and five minutes for centrifugation 5. A flowchart on the right side of FIG. 4 indicates the operating state of the centrifugal separator 10.

The process between centrifugation 1 and centrifugation 2 is regulated at 30 minutes so as not to be longer or shorter. Similarly, the process between centrifugation 2 and centrifugation 3 is regulated at 2 hours. The processes between centrifugations 3, 4, and 5 are unregulated. These are simple processes that can be performed quickly in sequence.

Next, steps in the 96-sample process shown in FIG. 4 will be described chronologically. First, centrifugation 1A from Group A is performed. Since 30 minutes of processing is performed in Group A after executing centrifugation 1A, centrifugation 1B from Group B can be performed during this time. When centrifugation 1B ends, the 30-minute processing in Group A is over, and centrifugation 2A is performed. Hence, it is not possible to perform centrifugation 1C from Group C. Next, centrifugation 2B is performed since the 30-minute processing in Group B ends when centrifugation 2A is over. At this time, since both Group A and Group B are in 2-hour periods of processing, the centrifugation 1C of Group C is first performed, followed by 30 minutes of processing and centrifugation 2C.

Next, the 2-hour process in Group A ends, and centrifugation 3A is performed. Subsequently, the 2-hour process in Group B ends, and centrifugation 3B is performed. After performing another prescribed process in Group B, centrifugation 4B is immediately performed. At this time, it is assumed that performing odd centrifugation on a separate sample is requested.

Next, after the 2-hour process stipulated for Group C ends, centrifugation 3C is performed. For convenience, this process is followed in sequence by centrifugation 4C and centrifugation 5C, thereby completing the entire protocol for Group C.

Next, centrifugation 4A and centrifugation 5A are performed, completing the entire protocol for Group A, after which centrifugation 5B is performed, thereby completing the entire protocol for Group B.

Since the above processes are performed on a single centrifugal separator 10, the operating status of the centrifugal separator 10 during the 96-sample process is that shown in the flowchart on the right side of FIG. 4. Specifically, the centrifugal separator 10 first performs centrifugation 1A (S51), followed by centrifugation 1B (S52), centrifugation 2A (S53), and so on in sequence to centrifugation 5B (S66).

Next, operations for the centrifugation processes performed in the 96-sample process will be described with reference to the flowcharts in FIGS. 4 and 5. In S71 of FIG. 5, the user enables the counter 4 by performing a prescribed operation, such as pressing the runtime select button (TIME) 312 and temperature select button (TEMP) 313 simultaneously. At this time, the runtime display unit 302 displays the count during the previous counter operation for three seconds, for example, and the temperature display unit 303 displays the number of centrifugation processes set for the previous counter operation for three seconds. At the same time, in S72 the counter operation lamp (RUN COUNTER) 304 flickers to indicate that the displayed value is the count.

Since this is the start of the 96-sample process, the count for the counter 4 is reset to 0 through a prescribed operation, such as pressing and holding the cancellation button (CE) 315 for 1 second during the three seconds that the count is displayed or pressing the decrement button 317 during these three seconds. Further, it is possible to modify the setting for the number of centrifugation processes by pressing the temperature select button (TEMP) 313 for 1 second during the three seconds that the setting is displayed. The setting can subsequently be changed by pressing the increment button 316 or decrement button 317. Since the centrifugation process is performed five times on samples in each of the three groups, the number of centrifugation processes is set to 15.

After the three seconds have elapsed, the runtime display unit 302 and temperature display unit 303 return to their normal displays of run time and temperature, respectively, and in S73 the counter operation lamp (RUN COUNTER) 304 flashes to indicate that the counter operation is enabled. At this point, the process has reached centrifugation 1A in S51. Since centrifugation 1A is performed for 10 minutes at 20° C., the runtime display unit 302 displays “10” and the temperature display unit 303 displays “20 ”.

In S74 the user sets the samples to be separated in the rotor 1. Since centrifugation 1A is being performed, the samples to be separated are samples in Group A. In S75 the user presses the start button (START) 318 to begin centrifugation.

The controller 6 detects that an operation has been performed to start centrifugation and in S76 increments the value saved by the counter 4 by one in order to count the number of centrifugation processes. Hence, the count value of the counter 4 is “1” when performing centrifugation 1A. At the same time, in S77 the controller 6 begins driving the motor 5 to perform centrifugation.

Next, when the user halts centrifugation by pressing the stop button (STOP) 319 on the centrifugal separator 10 in S78, for example, in S79 the controller 6 decelerates and halts the motor 5.

In S80 the runtime display unit 302 and temperature display unit 303 display values for the previous counter operation for a period of three seconds, while the counter operation lamp (RUN COUNTER) 304 flashes to indicate that the displayed values are count values. In this way, the user can confirm the displayed count value to determine the centrifugation number. For example, after completing centrifugation 1A, the runtime display unit 302 displays “01”, and the temperature display unit 303 displays “15”.

After three seconds have elapsed, in S81 the runtime display unit 302 and temperature display unit 303 return to their normal displays of runtime and temperature, respectively, and the counter operation lamp (RUN COUNTER) 304 flashes in order to indicate that the counter operation is still enabled. Subsequently, in S82 the user opens the operation/display unit 3 and removes the samples for Group A. At this time, the user can load the next samples.

In S83 the user determines whether the count viewed in S80 has reached the scheduled number. If the count has not reached the scheduled number, then the user returns to S74 and loads the next samples. When the count value has reached the scheduled number, in S84 the user resets the value saved by the counter to 0 by performing a prescribed operation, such as pressing both the runtime select button (TIME) 312 and temperature select button (TEMP) 313 simultaneously and subsequently pressing the cancellation button (CE) 315 for one second during the three seconds that the counter value is displayed. In this case, the scheduled number is the setting “15” for the number of centrifugation processes. In S85 the user performs a prescribed operation, such as pressing both the runtime select button (TIME) 312 and temperature select button (TEMP) 313 simultaneously and subsequently pressing and releasing the cancellation button (CE) 315 during the three seconds that the count value is displayed to disable the counter so that the counter is in a non-operating state. Here, the cancel button is pressed for a short time, such as no more than one second. In S86 the counter operation lamp (RUN COUNTER) 304 turns off to indicate that the counter has been disabled.

During the process described above, the counter 4 counts the number of times that the user presses the start button (START) 318 and displays the count value on the operation/display unit 3. Hence, without making a conscious effort, the user is always aware of the number of operations performed with the centrifugal separator 10.

FIG. 6 shows steps in a process for interrupting the 96-sample process or the like in which the number of centrifugation operations is being counted in order to perform a separate centrifugation process, as in S60 of FIG. 4. This interrupt process will be described next.

In S91 of FIG. 6, the user first performs a prescribed operation, such as pressing both the runtime select button (TIME) 312 and temperature select button (TEMP) 313 simultaneously and subsequently pressing and releasing the cancellation button (CE) 315 within one second during the three seconds that the count value is displayed in order to disable the counter 4 so that the counter 4 is in a non-operating state. In S92 the user loads samples in the rotor 1 and in S93 presses the start button (START) 318 to start centrifugation. At this time, the controller 6 detects that an operation has been performed to start centrifugation. However, the counter 4 is in a non-operating state and therefore does not count this centrifugation process.

In S94 the controller 6 drives the motor 5 to perform centrifugation. In S95 the user presses the stop button (STOP) 319 to halt centrifugation or centrifugation is automatically halted by the centrifugal separator 10 after a prescribed time has elapsed. At this time, the controller 6 decelerates and halts the motor 5 in S96. When the next centrifugation process is performed in S61 of FIG. 4, a prescribed operation is performed to set the counter 4 in the operating state for counting the number of centrifugation processes. At this time, the counter 4 resumes counting from the count value saved prior to the interruption.

The following process is performed if the count value increases unexpectedly during the 96-sample process sample process when a separate centrifugation operation is performed without setting the counter to the non-operating state, for example. For example, it can be effective to add a function for decrementing the count value by one each time the decrement button 317 is pressed while the count value is displayed for three seconds. As described above, the count value is displayed through a prescribed operation, such as pressing both the runtime select button (TIME) 312 and temperature select button (TEMP) 313 simultaneously. It is also effective to add a function for incrementing the count value by pressing the increment button 316 during this time in case the user accidentally decreases the count value too far.

With the centrifugal separator 10 according to the first embodiment described above, the controller 6 detects when the start button (START) 318 has been pressed to start centrifugation and increments the count value in the counter 4 by rotor 1 when the counter 4 has been set to the operating state through a prescribed operation. Further, since the runtime display unit 302 and temperature display unit 303 display the count value in the counter 4 and the setting for the number of centrifugation processes, respectively, the user can visually confirm the progress of operations.

When the work must be interrupted, the counter 4 can be set to the non-operating state through a prescribed operation so that the counter 4 does not count centrifugation processes performed during the interruption. Further, if the count value is accidentally incremented during the interrupt process, the user can adjust the count value through prescribed operations.

Next, a centrifugal separator according to a second-embodiment of the present invention will be described with reference to FIGS. 7 through 12. In the second embodiment, the centrifugal separator has a plurality of counters, and the user selects the counter to be used for counting centrifugation processes. In the following description, components that have essentially the same or similar structure to those described in the centrifugal separator 10 according to the first embodiment have been designated with the same reference numerals to avoid duplicating description.

Unlike the centrifugal separator 10 according to the first embodiment, the centrifugal separator 10 according to the second embodiment has five counters. The second embodiment also differs in the configuration of the display unit for displaying the count values and the operating unit. Next, the structure and operations of the centrifugal separator 10 according to the second embodiment that differ from the first embodiment will be described.

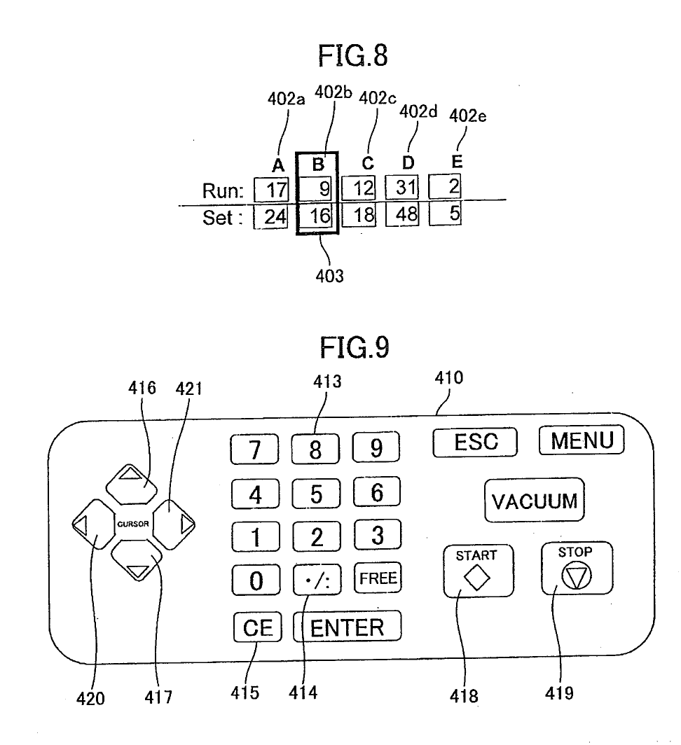

FIGS. 7 and 8 show sample views of the display unit in the second embodiment. FIG. 9 shows an example of the operating unit. The centrifugal separator 10 according to the second embodiment includes a display unit 400 and an operating unit 410 in place of the operation/display unit 3 provided in the centrifugal separator 10 according to the first embodiment.

As shown in FIG. 7, the display unit 400 includes a count display unit 402, a rotational speed display unit (SPEED) 404, a runtime display unit (TIME) 406, and a temperature display unit (TEMP) 408. Each of the rotational speed display unit (SPEED) 404, runtime display unit (TIME) 406, and temperature display unit (TEMP) 408 has an upper portion for displaying the current value and a lower portion for displaying the set value.

As shown in FIG. 8, the count display unit 402 has sub-display units 402a, 402b, 402c, 402d, and 402e corresponding to the five counters. Since the centrifugal separator 10 according to the second embodiment has five counters, as described above, these counters (not shown) will be referred to in the following description as counters A-E based on their correspondence with the sub-display units 402a, 402b, 402c, 402d, and 402e. The upper portion of the count display unit 402 displays the current count values for each of the counters A-E, while the lower portion displays the number of centrifugation processes that have been set for processes in which the counters A-E are used. A frame border 403 indicates which of the counters in the count display unit 402 is currently operating. In the example of FIG. 8, counter B is currently in an operating state. Further, the number of centrifugation processes to be counted by the counter B has been set to 16, while 9 of the centrifugation processes have been performed.

As shown in FIG. 9, the operating unit 410 is provided for enabling the user to set various display values for the display unit 400. The operating unit 410 includes a ten-key numeric keypad 413, a dot button 414, a cancel button (CE) 415, an increment button 416, a decrement button 417, a start button (START) 418, a stop button (STOP) 419, a left movement button 420, and a right movement button 421.

The ten-key numeric keypad 413 includes the numerical keys 0-9. The dot button 414 is used for displaying a dot symbol or the like and for enabling selection of one of the counters A-E. The cancel button (CE) 415 is used for canceling the current status and the like. The increment button 416 and decrement button 417 are used for adjusting the counter settings and count values. The start button (START) 418 is pressed to start a centrifugation process. The stop button (STOP) 419 is pressed to end the centrifugation process. The left movement button 420 and right movement button 421 function to move the frame border 403 in order to select a counter.

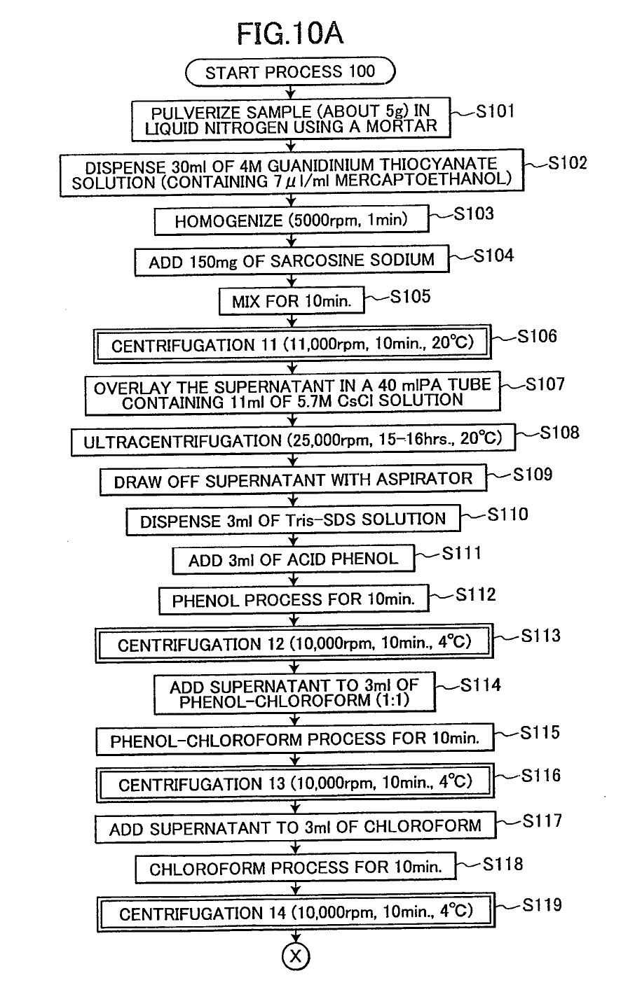

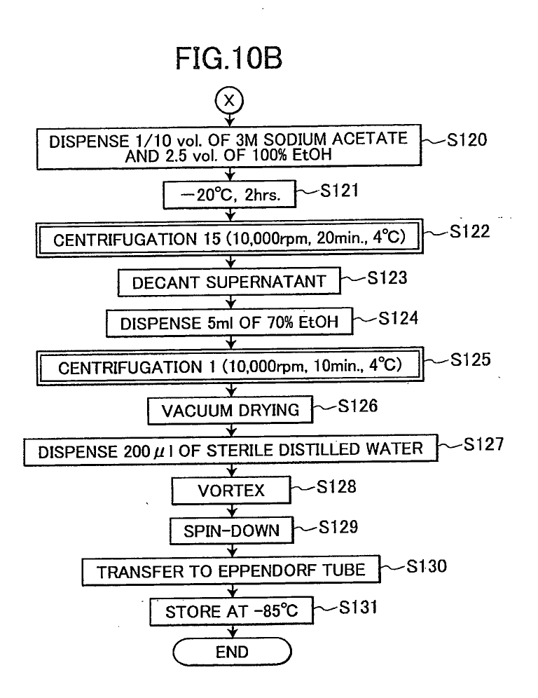

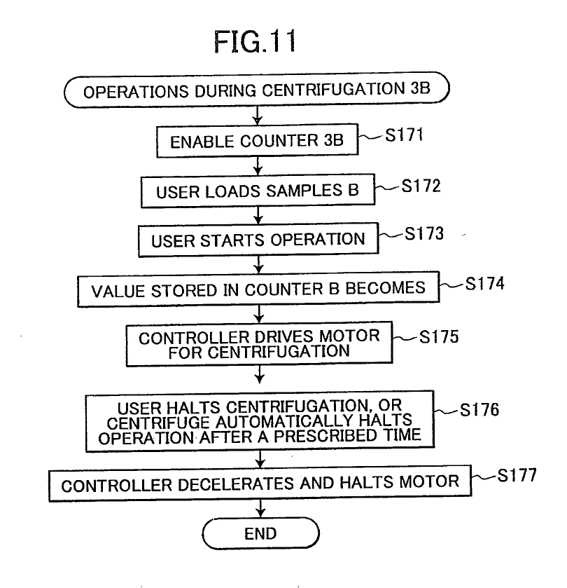

The following is a description of performing two types of processes to be counted separately using the centrifugal separator 10 according to the second embodiment. One of the processes is the 96-sample process in the process 20 described in the first embodiment. The other process is a process 100 shown in the flowcharts of FIGS. 10 and 11.

The process 100 is an example of an RNA extraction protocol. As shown in FIGS. 10 and 11, the process 100 has a total of six centrifugation steps referred to as centrifugations 11-16 and indicated in steps S106, S113, S116, S119, S122, and S125. The processes performed between each centrifugation step, indicated by S107-S112, S114-S115, S117-S118, S120-S121, and S123-S124, are different. Further, the rotational speed, runtime, and operating temperature are all set to 10,000 rpm, 10 minutes, and 4° C. for centrifugation steps 12, 13, 14, and 16. However, the rotational speed is set to 11,000 rpm and the operating temperature to 20° C. for centrifugation 11, while the runtime is set to 20 minutes for centrifugation 15.

Next, the 96-sample process and the process 100 performed using a single centrifugal separator 10 while counting centrifugation steps separately for each process will be described while referring to the flowcharts in FIGS. 4 and 12. In this example, counter B is used for the 96-sample process, and counter E for the process 100. The number of samples employed in the process 100 is set within a number that can be loaded in the centrifugal separator 10 at the same time.

Before beginning the processes, the numbers of centrifugation processes are set. To do this, an operation is performed for first enabling the counter B that will be used for the 96-sample process. More specifically, the user performs an operation, such as pressing and holding the dot button 414 for one second and subsequently presses the left movement button 420 or right movement button 421 to move the frame border 403 to the sub-display unit 402b, while the values are displayed in the count display unit 402 for three seconds. Next, the user performs a prescribed operation, such as pressing the dot button 414 for less than a second to enable the value in the lower portion of the sub-display unit 402b to be set. In this example, the user sets the number of centrifugation processes to 15 for the 96-sample process using the increment button 416 and decrement button 417, or the ten-key numeric keypad 413. Further, the user performs a prescribed operation, such as pressing the dot button 414 again for less than one second to enable the upper portion of the sub-display unit 402b to be set. At this time, the user sets the value in the upper section to “0” using the cancel button (CE) 415 or the ten-key numeric keypad 413.

In the same way, the user enables the counter E for the process 100, setting the lower portion of the sub-display unit 402e to “6” centrifugation processes using the increment button 416 or decrement button 417 or the like, and sets the upper portion of the sub-display unit 402e to “0” using the cancel button (CE) 415 or the like.

Next, the operations performed for centrifugation 3B in S58 of FIG. 4 will be described as an example with reference to FIG. 11. In S171 of FIG. 11, the user performs an operation to enable the counter B so that the counter B is in an operating state. More specifically, using the dot button 414, left movement button 420, right movement button 421, and the like, the user moves the frame border 403 to the counter B, while the display values are flashing. In S172 the user loads samples for Group B in the centrifugal separator 10. In S173 the user presses the start button (START) 418 to start the centrifugation process.

In S174 the controller 6 detects the operation to start the centrifugation process and increments the values stored in the counter B by one. At this time, the upper portion of the sub-display unit 402b displays the value “8”. In S175 the controller 6 drives the motor 5 to perform a centrifugation process. After the prescribed time has elapsed, in S176 the user presses the stop button (STOP) 419 or the like to halt the centrifugation or the centrifugal separator 10 automatically halts the centrifugation after the prescribed time has elapsed. In S177 the controller 6 decelerates and halts the motor 5. Next, the process in S59 of FIG. 4 is performed in the same way.

Subsequently, a separate centrifugation is performed as described in S60. In the second embodiment, this separate process will be centrifugation 11 of the process 100 in S106. Here, a process having substantially the same steps described in FIG. 11 is performed. However, the user enables the counter E for counting the number of centrifugation processes in the process 100, thereby placing the counter E in the operating state. When the controller 6 detects an operation for starting the centrifugation process, the value in the counter E is incremented by one. Hence, the counter E is used for counting only centrifugation processes performed in the process 100 separately from the processes performed in the 96-sample process. At this time, the upper portion of the sub-display unit 402b displays the value “1”.

S61-S66 in FIG. 4 are executed in the same way thereafter, completing the 96-sample process. At this time, the sub-display unit 402b for the counter B displays “15” in the upper portion thereof. While not shown in FIG. 4, the centrifugation process of the process 100 is continued in sequence until centrifugation 16 in S125. At this time, the upper portion of the sub-display unit 402e displays “6”.

If another separate centrifugation process is performed during this time, the user can selectively use one of the unused counters A, C, or D in the second embodiment. If the process does not require the number of centrifugation processes to be counted, the user can set the counter to a non-operating state by pressing and holding the dot button 414 for more than one second and by pressing and holding the cancel button (CE) 415 for more than one second during the three seconds that the count values are flashing, for example.

Further, if the count value is unexpectedly increased when the process is interrupted for another centrifugation operation, for example, it is effective to add a function enabling the user to perform an operation, such as pressing and holding the dot button 414 for one second, and decrementing the count value each time the decrement button 417 is pressed for the ensuing three seconds. It is also effective to add a function for incrementing the count value by pressing the increment button 416 during this period in case the user accidentally decreases the value too far.

As described above, the centrifugal separator 10 according to the second embodiment is provided with a plurality of counters and enables the user to select a counter to be operated during a process. Hence, when a single centrifugal separator 10 is used to perform a plurality of processes, each requiring a plurality of centrifugation processes, the user can visually confirm the progress of each process, reducing the risk of the user losing track of the progress and performing an incorrect process.

The configuration of the second embodiment facilitates the user in visually confirming count values by indicating the enabled count display unit with the frame border 403. Further, the upper portion of the count display unit 402 indicates the actual number of operations, while the lower portion displays the scheduled number of operations inputted previously. Accordingly, the user can easily understand the remaining number of operations. It is also possible to provide a counter for counting the total number of centrifugation processes performed. With this construction, the user can determine the usage frequency of the centrifugal separator 10.

Next, a variation of the second embodiment will be described. In this variation, the number of centrifugation processes is counted individually for each of the Groups A, B, and C in the 96-sample process of FIG. 4.

As is clear from the flowchart in FIG. 4, it is difficult to find a pattern in the order of processes performed by the centrifugal separator 10 in the 96-sample process. Since these operations are normally performed by one person, it is easy to lose track of the progress in each group when relying only on one's memory. At a time t shown in FIG. 4, Group A has progressed to centrifugation 3A, Group B to centrifugation 4B, and Group C has completed centrifugation 5C. Hence, although processing in the groups started in the order of Groups A, B, and C, the order of progress for these groups is now in the reverse order C, B, and A.

Therefore, it is effective to assign one counter to each group for counting the number of centrifugation processes separately. For example, counters A, B, and C can be assigned to Groups A, B, and C. With this construction, the values for counters A, B, and C at the time t described above is A=3, B=4, and C=5. Hence, by confirming the value of each counter, the user can easily confirm the progress in each group.

As described above, the centrifugal separator of the present invention provides an inexpensive means for following the progress in an operation including a plurality of centrifugal separating operations or to learn the usage frequency of the centrifugal separator.

While the invention has been described in detail with reference to specific embodiments thereof, it would be apparent to those skilled in the art that many modifications and variations may be made therein without departing from the spirit of the invention, the scope of which is defined by the attached claims. For example, in the first embodiment described above, the display unit for displaying the count value normally displays the centrifugation state, such as the runtime and temperature. However, it can be convenient to provide the operation/display unit 3 with a dedicated display unit by which the user can confirm these values at any time. Further, the present invention can easily be achieved in a centrifugal separator not provided with a counter function by connecting a commercial counter device having a reset function to the starter button or the like of the centrifugal separator.

In the preferred embodiments described above, the counters are incremented by one. However, the same objective can be met by inputting the scheduled value and decrementing the value for each operation.

Further, in the preferred embodiments described above, centrifugation processes are counted each time a start operation is performed. However, these processes can be counted based on the number of times the stop button is operated, the number of times the centrifugal separator performs a deceleration/halting operation, the number of times a door lock is released when the centrifugal separator has a door locking device, or the number of times the user opens the door.

The operation/display unit 3 of the first embodiment may also be provided with the display unit 400 and operating unit 410. With this construction, the runtime display unit 302 may display counter ID data identifying the counter currently being used.

In the preferred embodiments described above, the present invention is effective whether the centrifugal separator is used by a single person or whether a plurality of users is using the same centrifugal separator 10.

The centrifugal separator according to the present invention can be used in the field of molecular biology, as in pre-processes and other operations for genomic analysis that require execution of a plurality of centrifugation processes.

What is claimed is:

1. A centrifugal separator comprising:
a rotor having a holding portion for holding a sample subject to separation through centrifugation;
a motor operatively connected to the rotor for driving the rotor to rotate;
a controller that is configured to control the motor;
an operation/display unit that is configured to set and display drive operations of the motor controlled by the controller;
a counter unit that counts number of centrifugation processes; and
a count display unit that displays a value maintained by the counter unit indicating the number of centrifugation processes counted by the counter.

2. The centrifugal separator according to claim 1, further comprising a counter activating unit that activates the counter unit, the counter unit counting the number of centrifugation processes only when having been activated by the counter activating unit.

3. The centrifugal separator according to claim 2, wherein the counter unit comprises a plurality of counters, each counter being configured to count the number of centrifugation processes, wherein the counter activating unit selectively activates at least one of the plurality of counters, the at least one of the plurality of counters counting the number of centrifugation processes.

4. The centrifugal separator according to claim 1, wherein the number of centrifugation processes is counted by counting each time centrifugation is started.

5. The centrifugal separator according to claim 1, wherein the number of centrifugation processes is counted by counting each time centrifugation is stopped.

6. The centrifugal separator according to claim 3, further comprising a counter identifying data display unit that displays counter identifying data indicating the at least one of the plurality of counters selected by the counter activating unit.

7. The centrifugal separator according to claim 3, further comprising a target value display unit that displays a target count for the at least one of the plurality of counters selected by the counter activating unit.

8. The centrifugal separator according to claim 1, further comprising a count halting unit that halts centrifugation processes counting operations of the at least one of the plurality of counters.

9. The centrifugal separator according to claim 1, wherein the count display unit is disposed in the operation/display unit and functions to display an operating status of the centrifugal separator.
